(19) United States
(12) Patent Application Publication
(10) Pub. No.: US 2025/0077508 A1
(43) Pub. Date: Mar. 6, 2025

(54) Refining a Search Using Physiological Information

(71) Applicant: Google LLC, Mountain View, CA (US)

(72) Inventors: Ivan Poupyrev, Sunnyvale, CA (US); Gaetano Roberto Aiello, Bend, OR (US)

(73) Assignee: Google LLC, Mountain View, CA (US)

(21) Appl. No.: 18/952,779

(22) Filed: Nov. 19, 2024

Related U.S. Application Data
(63) Continuation of application No. 18/495,648, filed on Oct. 26, 2023, now Pat. No. 12,153,571.
Application No. 18/495,648 is a continuation of application No. 17/517,978, filed on Nov. 3, 2021, now Pat. No. 11,816,101.
Application No. 17/517,978 is a continuation of application No. 14/504,121, filed on Oct. 1, 2014, now Pat. No. 11,169,988.
(60) Provisional application No. 62/040,925, filed on Aug. 22, 2014.

(51) Int. Cl. G06F 16/242; G06F 3/01; G06F 16/2457; G06F 16/248; G06F 16/29; G06F 16/9537

(52) U.S. Cl. CPC G06F 16/242; G06F 3/017; G06F 16/24575; G06F 16/248; G06F 16/29; G06F 16/9537

(57) ABSTRACT

This document describes techniques and devices for a radar recognition-aided search. Through use of a radar-based recognition system, gestures made by, and physiological information about, persons can be determined. In the case of physiological information, the techniques can use this information to refine a search. For example, if a person requests a search for a coffee shop, the techniques may refine the search to coffee shops in the direction that the person is walking. In the case of a gesture, the techniques may refine or base a search solely on the gesture. Thus, a search for information about a store, car, or tree can be made responsive to a gesture pointing at the store, car, or tree with or without explicit entry of a search query.

### RELATED APPLICATIONS

This application is a continuation of and claims priority to U.S. Non-Provisional patent application Ser. No. 18/495,648, filed on Oct. 26, 2023, which in turn claims priority to U.S. Non-Provisional patent application Ser. No. 17/517,978, filed on Nov. 3, 2021, now U.S. Pat. No. 11,816,101, issued on Nov. 14, 2023, which in turn claims priority to U.S. Non-Provisional patent application Ser. No. 14/504,121, filed on Oct. 1, 2014, now U.S. Pat. No. 11,169,988, issued on Nov. 9, 2021, which in turn claims the benefit of U.S. Provisional Patent Application Ser. No. 62/040,925, filed on Aug. 22, 2014, the disclosures of which are incorporated in their entireties by reference herein.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Computer-aided searches are not only commonplace for billions of people, they are nearly essential in many people's day-to-day lives. Because of this, conventional search techniques use complex search algorithms to provide search results that are better and better tailored to what a person seeks when they enter a query for their search.

Even with these complex search algorithms, however, conventional search techniques can fail to provide a desired result. This can be due to a lack of information, such as when a person enters few or ambiguous search terms for a query. If a person enters a search query of “Best Italian Restaurant” the search algorithm may not know enough information to best perform the search-does the person mean within 10 kilometers of his current location? His hometown? At a city he will be visiting next week? Or does he want the best Italian Restaurant within some price limit? For these and other reasons, current techniques for performing computer-aided searches can fail to provide desired results.

### SUMMARY

This document describes techniques and devices for a radar recognition-aided search. Through use of a radar-based recognition system, gestures made by, and physiological information about, persons can be determined. In the case of physiological information, the techniques can use this information to refine a search. For example, if a person requests a search for a coffee shop, the techniques may refine the search to coffee shops in the direction that the person is walking. In the case of a gesture, the techniques may refine or base a search solely on the gesture. Thus, a search for information about a store, car, or tree can be made responsive to a gesture pointing at the store, car, or tree with or without explicit entry of a search query.

This summary is provided to introduce simplified concepts concerning radar recognition-aided searches, which are further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices enabling radar recognition-aided searches are described with reference to the following drawings. The same numbers are used throughout the drawings to reference like features and components:

FIG. 1 illustrates an example environment in which a radar recognition-aided search can be implemented.

FIG. 2 illustrates the radar-based recognition system and computing device of FIG. 1 in detail.

FIG. 3 illustrates an example method for performing a search using one or more search terms for a query and information about a gesture.

FIG. 4 illustrates a person with a gesture pointing down a street.

FIG. 5 illustrates an example method performing a search using information determined from a radar-recognized gesture and may or may not include a search query selected explicitly by a person.

FIG. 6 illustrates a television playing audio-visual media, a radar-based recognition system, a radar field, and a person performing a pointing gesture pointing at an object within the media.

FIG. 7 illustrates a person pointing to a building having a business.

FIG. 8 illustrates an example method performing a search based on a search query and radar-determined physiological information for a person.

FIG. 9 illustrates an example electronic device enabling, or in which techniques may be implemented that enable use of, a radar recognition-aided search.

### DETAILED DESCRIPTION

### Overview

This document describes techniques enabling radar recognition-aided searches. These techniques enable improved computer-aided searches through additional information provided by radar-recognized gestures and physiological information. The radar-based recognition system described herein permits recognition of a great breadth of gestures and physiological information and in a robust set of circumstances. The techniques, along with the radar-based recognition system, enable improved computer-aided searches and, in some cases, searches enabled with little or no explicit entry of a search query.

Consider, for example, a case where a person is watching a television program on a computing device. Assume that the person sees a car being driven during the television program. The techniques described herein permit the user, with as little as an audio statement of “what kind of car is that?” or even “what is that?” and a gesture pointing at the television screen, to receive search results for the particular car shown on the television.

Consider, as another example, a case where a person is standing on a corner in a city and requests a search for a best Indian restaurant and concurrently makes a sweeping gesture having about a 90-degree arc. The techniques may provide search results tailored to city blocks within that 90-degree arc that are within a reasonable distance from the person. Further still, the reasonable distance can be tailored to physiological information determined for the person as well, such as information indicating that the person is hungry or dehydrated.

This document now turns to an example environment, after which example radar-based recognition systems and radar fields, example methods, and an example computing system are described.

### Example Environment

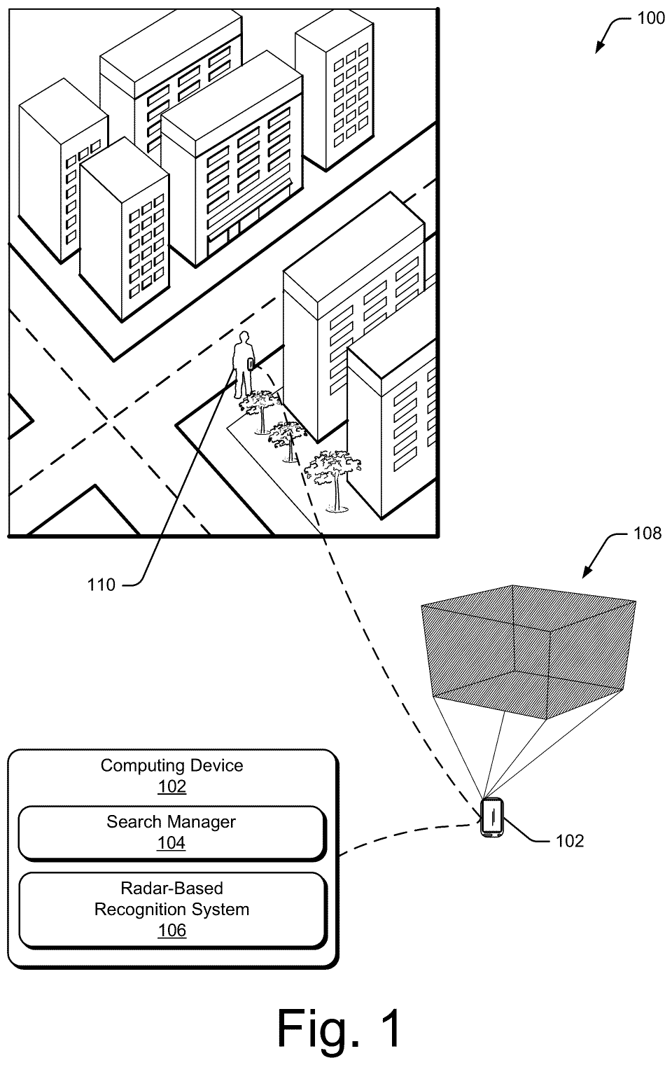

FIG. 1 is an illustration of example environment 100 in which techniques enabling radar recognition-aided searches and an apparatus including a radar-based recognition system may be embodied. Environment 100 includes an example computing device 102 having a search manager 104 and a radar-based recognition system 106. Radar-based recognition system 106 provides a radar field 108 configured to recognize gestures or physiological information of person 110. Search manager 104 searches based on information about person 110 or a gesture made by person 110, and in some cases also based on a search query selected by person 110.

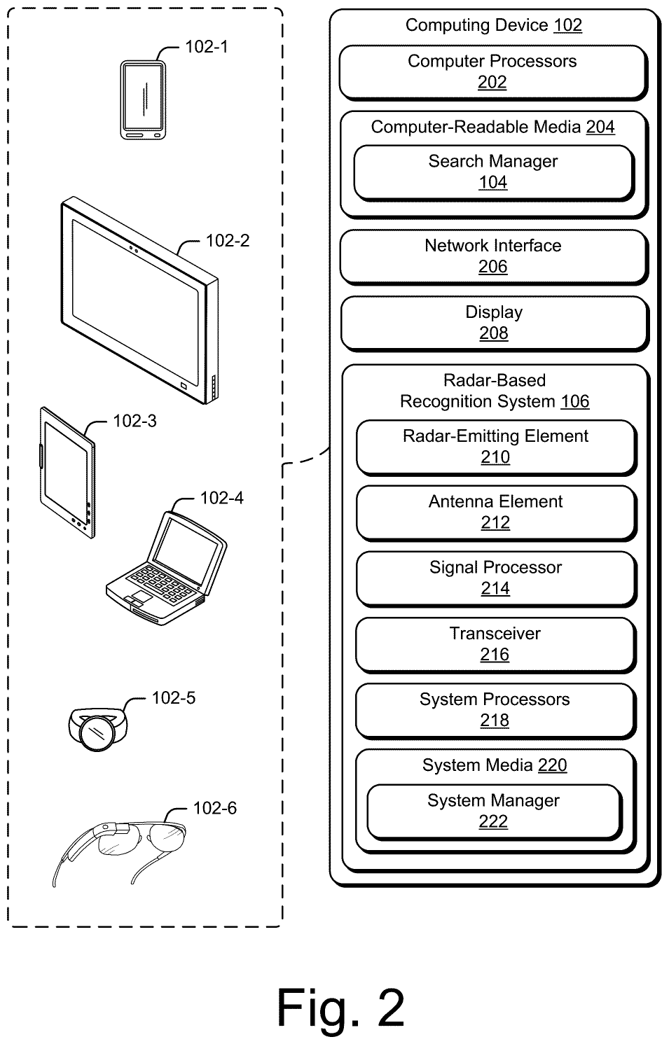

Example configurations of computing device 102 are shown in FIG. 2, which depicts search manager 104, radar-based recognition system 106, and other components of computing device 102 in greater detail. Here, computing device 102 is illustrated as various non-limiting example devices: smartphone 102-1, television 102-2, tablet 102-3, laptop 102-4, computing bracelet 102-5, and computing spectacles 102-6, though other devices may also be used, such as home automation and control systems, entertainment systems, audio systems, desktop computers, other home appliances, security systems, netbooks, smartphones, and e-readers. Note that computing device 102 can be wearable, non-wearable but mobile, or relatively immobile (e.g., desktops and appliances). Note also that radar-based recognition system 106 can be used with, or embedded within, many different computing devices or peripherals, such as in automobiles or as an attachment to a laptop computer.

Further, radar field 108 can be invisible and penetrate some materials, such as textiles, thereby further expanding how the radar-based recognition system 106 can be used and embodied, e.g., to determine a person's heart rate or a gesture made wearing gloves or with an occlusion between radar-based recognition system 106 and the person's hands. While examples shown herein generally show one radar-based recognition system 106 per device, multiples can be used, thereby increasing a number and complexity of gestures and physiological information, as well as resolution, accuracy, and robust recognition.

Computing device 102 includes one or more computer processors 202 and computer-readable media 204, which includes memory media and storage media. Applications and/or an operating system (not shown) embodied as computer-readable instructions on computer-readable media 204 can be executed by processors 202 to provide some of the functionalities described herein. Computer-readable media 204 also includes search manager 104.

Computing device 102 may also include network interfaces 206 for communicating data over wired, wireless, or optical networks and display 208. By way of example and not limitation, network interface 206 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

Radar-based recognition system 106, as noted above, is configured to recognize gestures and determine physiological information. To enable this, radar-based recognition system 106 includes a radar-emitting element 210, an antenna element 212, and a signal processor 214. Generally, radar-emitting element 210 is configured to provide a radar field, in some cases one that is configured to penetrate fabric or other obstructions and reflect from human tissue. These fabrics or obstructions can include wood, glass, plastic, cotton, wool, nylon and similar fibers, and so forth, while reflecting from human tissues, such as a person's hand.

This radar field can be a small size, such as about one millimeter to 1.5 meters, or an intermediate size, such as about one to about 30 meters. In the intermediate size, antenna element 212 and signal processor 214 are configured to receive and process reflections of the radar field to provide large-body gestures based on reflections from human tissue caused by body, arm, or leg movements, though smaller and more-precise gestures can be sensed as well. Example intermediate-sized radar fields include those in which a user makes a gesture to point in a direction or at an object on a television.

Radar-emitting element 210 can instead be configured to provide a radar field that is relatively small. Radar field 108 as illustrated in FIG. 1 is one such relatively small field, and is configured for sensing gestures and physiological information for a person in contact with a mobile computing device, such as computing bracelet 102-5.

Radar-emitting element 210 can be configured to emit continuously modulated radiation, ultra-wideband radiation, or sub-millimeter-frequency radiation. Radar-emitting element 210, in some cases, is configured to form radiation in beams, the beams aiding antenna element 212 and signal processor 214 to determine which of the beams are interrupted, and thus locations of interactions (e.g., human skin) within the radar field.

Antenna element 212 is configured to receive reflections of, or sense interactions in, the radar field. In some cases, reflections include those from human tissue that is within the radar field, such as skin on a person's arm to determine the person's temperature, or a hand or finger movement to perform a gesture. Antenna element 212 can include one or many antennas or sensors, such as an array of radiation sensors, the number in the array based on a desired resolution and whether the field is a surface or volume.

Signal processor 214 is configured to process the received reflections within the radar field to aid in determining a gesture or physiological information. Antenna element 212 may, in some cases, be configured to receive reflections from multiple human tissue targets that are within the radar field and signal processor 214 be configured to process the received interactions sufficient to differentiate one of the multiple human tissue targets from another of the multiple human tissue targets. These targets may include hands, arms, legs, head, and body, from a same or different person.

The field provided by radar-emitting element 210 can be a three-dimensional (3D) volume (e.g., hemisphere, cube, volumetric fan, cone, or cylinder) to sense in-the-air gestures, though a surface field (e.g., projecting on a surface of a person) can instead be used. Antenna element 212 is configured, in some cases, to receive reflections from interactions in the radar field of two or more targets (e.g., fingers, arms, or persons), and signal processor 214 is configured to process the received reflections sufficient to provide data by which to aid in the determination of gestures and/or physiological information.

To sense gestures through obstructions, radar-emitting element 210 can also be configured to emit radiation capable of substantially penetrating fabric, wood, and glass, for example. In such cases, antenna element 212 is configured to receive the reflections from the human tissue through the fabric, wood, or glass, and signal processor 214 is configured to analyze the received reflections even with the received reflections partially affected by passing through the obstruction twice. For example, the radar passes through a fabric layer interposed between the radar emitter and a human arm, reflects off the human arm, and then back through the fabric layer to the antenna element.

Radar-based recognition system 106 enables recognition of many different gestures, such as those usable with current touch-sensitive displays, e.g., swipes, two-finger pinch, spread, rotate, tap, and so forth. Other gestures are also enabled that are complex, or simple but three-dimensional, examples include the many sign-language gestures, e.g., those of American Sign Language (ASL) and other sign languages worldwide. A few examples of these are: an up-and-down fist, which in ASL means “Yes”; an open index and middle finger moving to connect to an open thumb, which means “No”; a flat hand moving up a step, which means “Advance”; a flat and angled hand moving up and down; which means “Afternoon”; clenched fingers and open thumb moving to open fingers and an open thumb, which means “taxicab”; an index finger moving up in a roughly vertical direction, which means “up”; and so forth. These are but a few of many gestures that can be sensed as well as be mapped to associated meanings, which can in turn be used to make or refine computer-aided searches.

Radar-based recognition system 106 also includes transceiver 216, which is configured to transmit gesture/physiological information to a remote device, though this may not be needed when radar-based recognition system 106 is integrated with computing device 102. When included, gesture/physiological information can be provided in a format usable by a remote computing device sufficient for the remote computing device to determine the physiological information or the information about the gesture in those cases where the gesture is not determined by radar-based recognition system 106 or computing device 102.

In more detail, radar-emitting element 210 can be configured to emit microwave radiation in a 1 GHz to 300 GHz range, a 3 GHz to 100 GHz range, and narrower bands, such as 57 GHz to 63 GHZ, to provide the radar field. This range affects antenna element 212's ability to receive interactions, such as to track locations of two or more targets to a resolution of about two to about 25 millimeters. Radar-emitting element 210 can be configured, along with other entities of radar-based recognition system 106, to have a relatively fast update rate, which can aid in resolution of the interactions.

By selecting particular frequencies, radar-based recognition system 106 can operate to substantially penetrate clothing while not substantially penetrating human tissue, or penetrating human tissue differently (e.g., bone and skin). Further, antenna element 212 or signal processor 214 can be configured to differentiate between interactions in the radar field caused by clothing from those interactions in the radar field caused by human tissue, such as by analyzing variations in patterns, frequency, and/or strength of reflected signals. Thus, a person wearing gloves or a long sleeve shirt that could interfere with sensing gestures with some conventional techniques can still be sensed with radar-based recognition system 106.

Radar-based recognition system 106 may also include one or more system processors 218 and system media 220 (e.g., one or more computer-readable storage media). System media 220 includes system manager 222, which can perform various operations, including determining a gesture based on gesture data from signal processor 214, mapping the determined gesture to a pre-associated meaning, and causing transceiver 216 to transmit the meaning to an entity that performs the requested search.

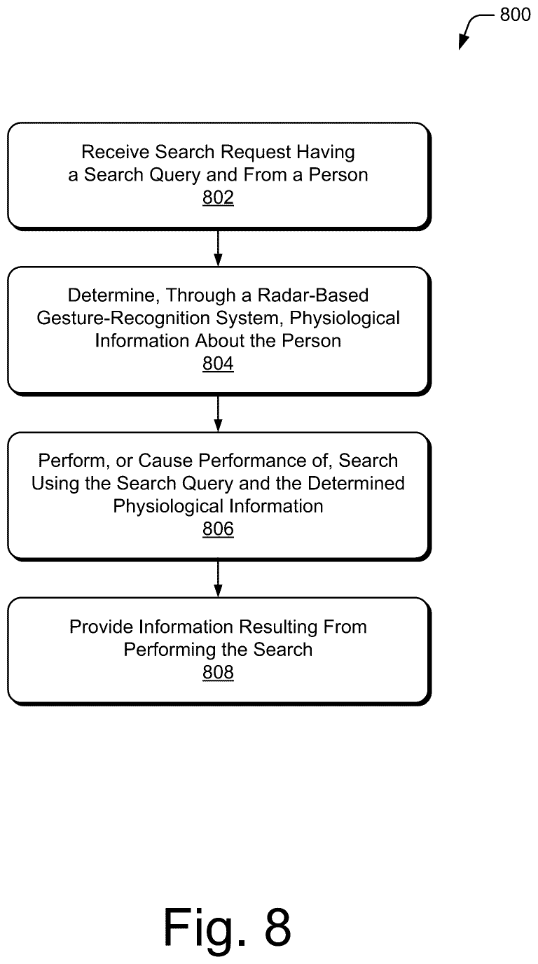

These and other capabilities and configurations, as well as ways in which entities of FIGS. 1 and 2 act and interact, are set forth in greater detail below. These entities may be further divided, combined, and so on. The environment 100 of FIG. 1 and the detailed illustrations of FIGS. 2 and 8 illustrate some of many possible environments and devices capable of employing the described techniques.

### Example Methods

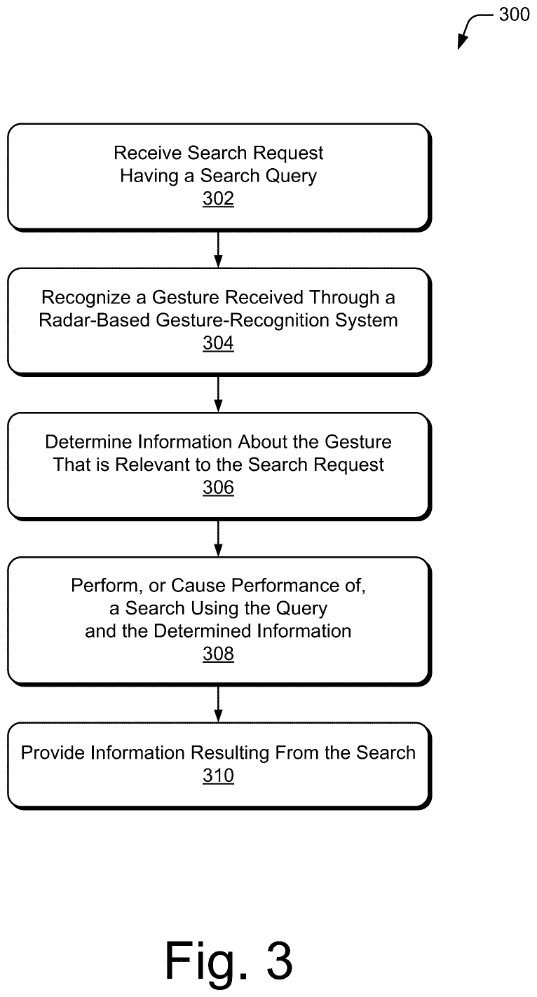

FIGS. 3, 5, and 8 depict methods enabling radar recognition-aided searches. Method 300 performs a search using a search query and information about a gesture. Method 500 performs a search using information determined from a radar-recognized gesture, and may or may not include a search query selected explicitly by a person. Method 800 performs a search based on a query and radar-determined physiological information for a person.

These methods and other methods herein are shown as sets of operations (or acts) performed but are not necessarily limited to the order or combinations in which the operations are shown herein. Further, any of one or more of the operations may be repeated, combined, reorganized, or linked to provide a wide array of additional and/or alternate methods. In portions of the following discussion reference may be made to environment 100 of FIG. 1 and as detailed in FIG. 2, reference to which is made for example only. The techniques are not limited to performance by one entity or multiple entities operating on one device.

At 302, a search request having a search query is received. The search request can be received in various manners, such as through an audio-reception system, a touch screen, keyboard, and so forth.

At 304, a gesture received through a radar-based recognition system is recognized. As noted above, this gesture can be received through radar-based recognition system 106 detailed above. In more detail, radar-based recognition system 106 may provide a radar field, which can be caused by one or more of search manager 104, system manager 222, or signal processor 214. Thus, system manager 222 may cause radar-emitting element 210 of radar-based recognition system 106 to provide (e.g., project or emit) one of the described radar fields noted above, after which one or more interactions by an actor (arm, hand, whole person) in the radar field are sensed via reflections received by antenna element 212. The reflections for the interaction can be processed by signal processor 214, which may provide gesture data for later determination as to the gesture intended, such as by system manager 222 or search manager 104. Note that radar-emitting element 210, antenna element 212, and signal processor 214 may act with or without processors and processor-executable instructions. Thus, radar-based recognition system 106, in some cases, can be implemented with hardware or hardware in conjunction with software and/or firmware.

At 306, information about the gesture that is relevant to the search request is determined. Determining information about the gesture that is relevant to the search request may include comparing potential meanings associated with the gesture and refine the search using the determined meaning. Thus, assume that a particular gesture of a pointed finger moving in a circle can mean “wrap it up” or “around me” or “circle.” This gesture, in combination with a commensurate search request to “find a best place to sit outside” can be determined to be “around me” rather than “wrap it up” or “circle.” Thus, the search is refined and a closest park bench around the user is indicated.

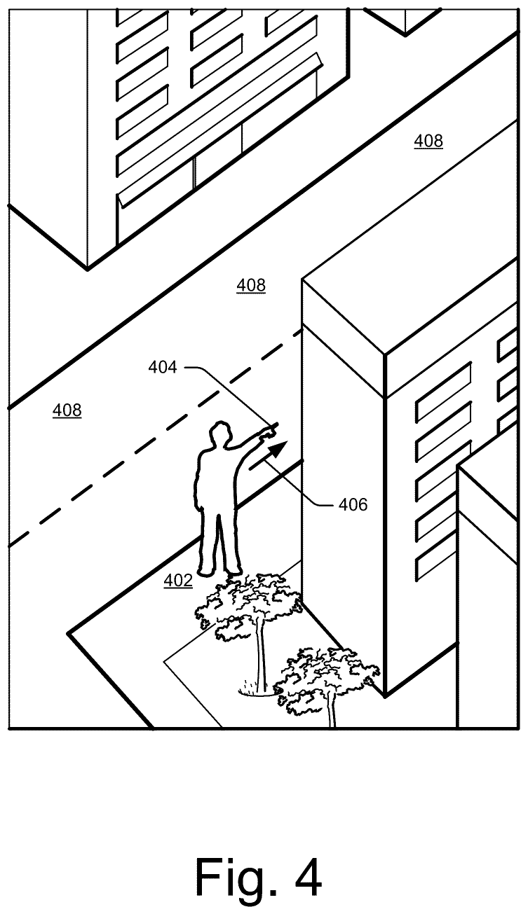

The gesture information may instead indicate a geographical direction, such as a building, object, street, area, or alleyway. By way of illustration, consider FIG. 4, which shows a person 402 making a gesture 404 that indicates a direction 406 down a street 408. Thus, search manager 104 may receive a search request (e.g., through a mobile computing device), and determine information about gesture 404 indicating direction 406. This direction 406 can then be further analyzed based on the person's or device's location (e.g., global position system (GPS) enabled devices) and/or which street or object to which the person is pointing.

The gesture information may indicate a control input associated with the gesture. Assume that a user makes a gesture with a thumb-up first turning in a clockwise direction. Assume also that this gesture is mapped to the following inputs, three of which are control inputs: i) turn up volume; ii) fast forward; iii) aunt (from American Sign Language); and iv) reset to default settings (from prior user selection). Thus, one, for “aunt” is a word mapped to the gesture, and the other three, “turn up volume,” “fast forward,” and “reset to default settings” are controls recognized by some device or application that are mapped to this same gesture. Thus, at 306, search manager 104 determines which of these three control inputs include information relevant to the search.

By way of another example, assume that a gesture of a hand's fingers and thumb spreading apart is mapped to a “zoom in” control input as well as an “expand interface to cover display” control input. Search manager 104 can determine that the “zoom in” control input is relevant based on the search request of “find best gyro shop” to mean the menu of the gyro shop as a way to “zoom in” to the search results.

At 308, a search is performed using the search query and the determined information from the gesture. This search can be caused to be performed by a computing device that receives the gesture and query or by the computing device itself. Thus, the computing device may pass the query and gesture information to a remote device (e.g., a server) to perform the search. Also, the search can be performed using the query and then refined or performed with both the query and gesture information. Thus, the determined information for the gesture may be used in a search or to refine a prior search that used the search query.

Continuing the ongoing example shown in FIG. 4, assume that the search query received at operation 302 is “find me a good Café”. Search manager 104 then determines, as noted above, that the gesture indicates street 408. Based on these, search manager 104 performs a search for a Café with good ratings that is down street 408 from person 402 (e.g., cafe's with that street's address and within a reasonable walking distance).

At 310, search results from performing the search using the search query and the determined information are provided, such as to a person requesting the search. These search results can be in various forms, such as locations on a map, a list of terms or webpages, and presentation of media, such as when a search results in a song being found. Concluding the example of FIG. 4, assume an audio system reads the result or a display of a mobile device (e.g., display 208 of computing spectacles 102-6 of FIG. 2) presents a list or map showing the cafés.

To further illustrate ways in which method 300 may be performed, consider the following three examples. In a first example, assume that a search request is received through an audio communication system and that determining information at operation 306 is responsive to and based on a gesture being received commensurate with receiving the search request through the audio communication system. Thus, a user speaks a query for a search and a gesture is received and analyzed based on being commensurate with the audio request.

In a second example, assume that a gesture points at an object commensurate with receiving a search request, such as “what kind of tree is that?” and pointing at a tree. Gesture information can be determined, based on the details provided by radar-based recognition system 106, to be pointing at particular tree. This tree can be determined with a camera or other sensor of a mobile computing device also used in the search or based on a location of the user and known tree types near the person and in the appropriate direction. Search manager 104, with this information (e.g., a name of the tree), can present results indicating the informal name “Pecan Tree,” and search to find the technical name “Carya illinoinensis,” that it is native to the Americas, and has only very recently been domesticated as a crop in 1880 AD. Aside from the greater implications of computer-aided searching that benefit generally from these techniques, consider a child wearing computing spectacles 102-6 that use these techniques. The child could discover an amazing breadth and depth of information about her world through this teaching tool.

In a third example, consider a case where search manager 104 receives, through a mobile or non-mobile device, a request for “a fruit smoothie” along with making a stepped gesture known to have a meaning of a path or map. Search manager 104 can determine that this information for the gesture indicates a path and, based on a time of day and a known path that the person takes to work, perform a search for a fruit smoothie along the person's typical walk and subway path to work. Thus, search manager 104 can perform or refine the search to the intended path and provide places at which to get a fruit smoothie along that intended path.

Note that in some cases a person's gestures have a meaning or a control input associated with it, and that these can be determined as information relevant to a search. In other cases, gestures indicate a direction and thus some object, street, location, and so forth that is relevant to a search. In still another example noted below, a gesture indicates an entity relevant to a search that is in media. In some cases this media is an audio-visual program, such as a television program where the entity indicated by the gesture is an object in the program—e.g., a car or person. In some other cases this media is a document, list, or other presentation of data, such as a table of data or a list of search results. Indicating, through a gesture, an item in the search results can then refine the search based on the item or select the item. If refining the search, the gesture permits a simple and easy way to drill down into the search results. Gesture information therefore encompasses a broad variety of information relevant to computer-aided searching.

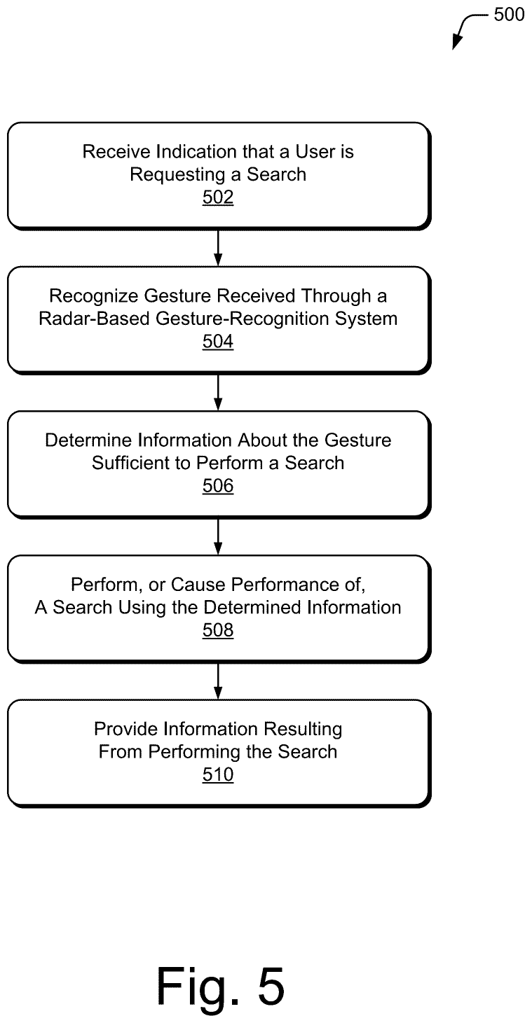

Turning to FIG. 5, consider method 500, which performs a search using information determined from a radar-recognized gesture. This information may or may not include a search query selected explicitly by a person.

At 502, an indication that a person is requesting a search is received. This indication can be received as an explicit research request, such as a search query (e.g., words) entered into a data-entry field. In some cases, however, the indication can be simply a gesture, such as the gesture received at operation 504 below or some other gesture.

At 504, a gesture received through a radar-based recognition system is recognized. Note that this gesture can be recognized, and information about it determined, responsive to another gesture received through the radar-based recognition system and determined to indicate a search.

At 506, information about the gesture sufficient to perform a search is determined. This information can include the various types of information noted above. Note that the methods may, prior to performing the search using the determined information, prompt the person for additional information, receive the additional information, and perform the search with the additional information. This can be useful in cases where search manager 104 determines that the information determined at operation 506 is not sufficient for adequately directed or detailed search results.

As noted above, methods 500 may operate with little or no non-gesture inputs. Consider, by way of example, a person desiring to find food down a particular street and that, due to bad weather, loud surroundings, or a physical disability (e.g., being mute), does not make audio or touch selections. The person may select, with a gesture to indicate that she is requesting a search, to search and then select one or more other gestures. Assume that she makes a circular gesture in the air, then puts her hand to her mouth as a second gesture, and then points down a street as a third gesture. Search manager 104 may determine that the circular gesture indicates a search is desired, the second gesture is determined to be information having a meaning of “find food or restaurants,” and the third gesture is also recognized as a geographical direction. Based on these gestures, information can be determined to refine to search to food or restaurants down the street that the person pointed.

At 508, the requested search is performed using the determined information. Note that the search can be performed using only the determined information from the gesture, though this is not required. In some cases, however, additional information is used, such as a search query received at operation 502, or search manager 104 can find other contextual information, such as that the computing device through which the gesture is received is playing media, and thus that this media can be used as additional information, or location data indicating that the person is at a park, and so forth.

At 510, the search results resulting from performing the requested search using the determined information are provided. Concluding the example in which only gestures are used, a computing device provides food stores and restaurants down the street in one of the various manners described herein.

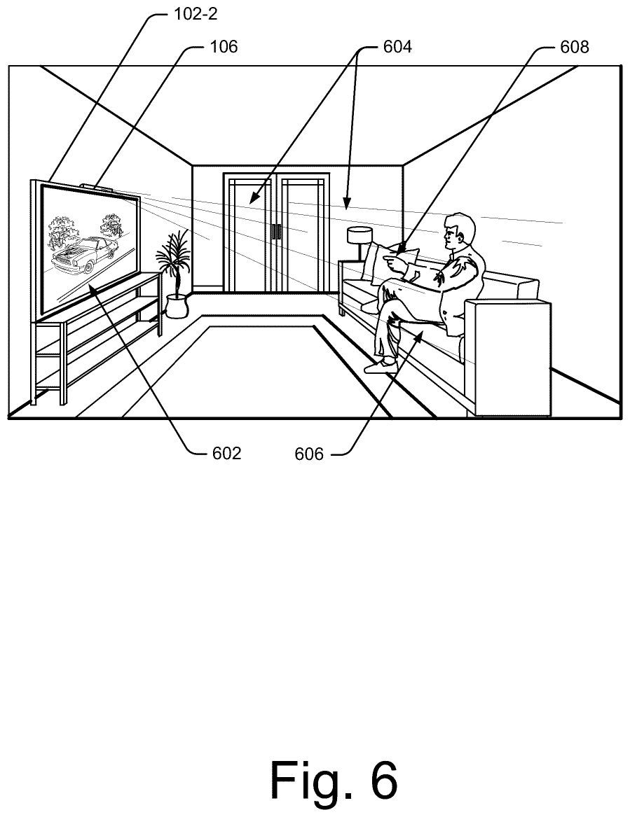

To illustrate ways in which method 500 may be operate, consider FIG. 6. FIG. 6 shows television 102-2 playing audio-visual media 602, radar-based recognition system 106 as a peripheral to television 102-2, a radar field 604 generated by radar-based recognition system 106, and a person 606 performing a pointing gesture 608. Here assume that person 606 is watching audio-visual media 602 (e.g., a movie) and sees a car on television 102-2. Assume also that persons 606 wants to know more about this car. The techniques, either following method 300 or 500 or some combination thereof, permit person 606 to search for information about this car with as little as a statement “what kind of car is that” and pointing gesture 608 or a gesture indicating a search is desired and pointing gesture 608, even without any statement. Television 102-2, through radar-based recognition system 106, can determine sufficient information about the gesture and, by search manager 104 analyzing audio-visual media 602 at a time commensurate with the gesture, perform or refine a search. Then search manager 104 causes television 102-2's display or speakers to present results of the search.

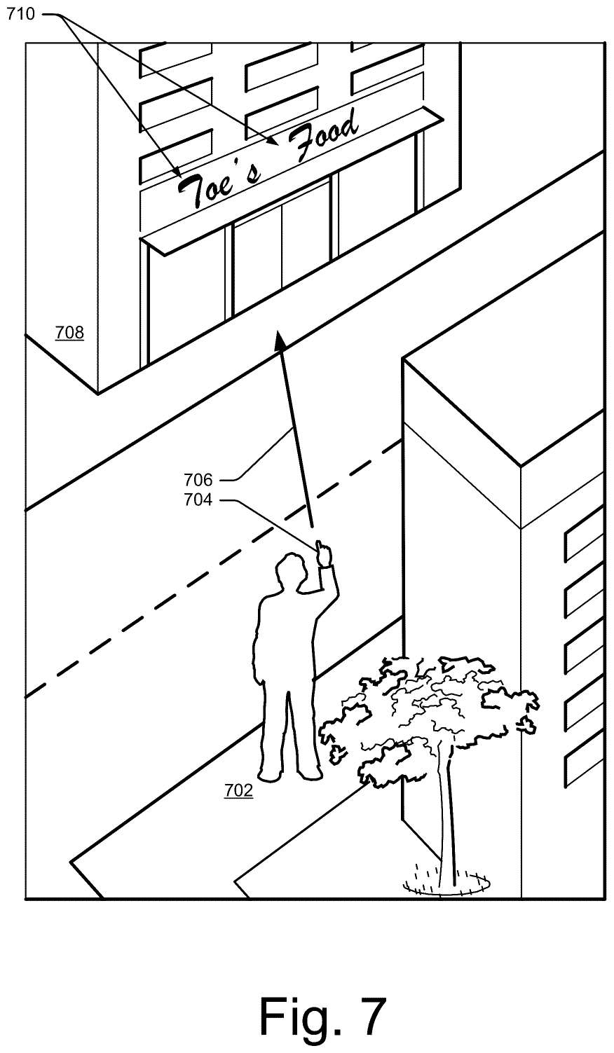

To illustrate another way in which methods 300 or 500 may be operate, consider FIG. 7, which shows a person 702 pointing with a gesture 704 along a direction 706 to a building 708 having a business 710 (Joe's Food). The techniques, with or without a search query, can determine sufficient information about gesture 704 to perform a search to find out more about businesses at building 708, such as Joe's Food. Thus, search manager 104 can determine the building that is being pointed out, businesses at the building, a likely business of interest based on a prominent storefront or large percentage of the square footage of building 708, and provide search results indicating that Joe's Food is not a grocery, but is instead a high-end seafood restaurant. Additional information may also be provided to person 702, such as a menu or hours of operation for Joe's Food. Refining the search be responsive to the person indicating some search query, such as “what is Joe's,” but that is not required.

Turning to FIG. 8, method 800 performs a search based on a search query and radar-determined physiological information for a person. Thus, a search can be performed using information about a person's physiology, independent or in conjunction with other search information.

At 802, a search request having a search query is received. This search request can be received from an input device, such as a computing device, audio recognition software, user interface, and so forth. The search request can be associated with a person, such as one associated with the input device. This association can be based on the input, or having a right to control the input device.

At 804, physiological information about the person is determined through a radar-based recognition system. Details of ways in which radar-based recognition system 106 operates are described above and, as noted, can differentiate objects, fabric, and other materials from human tissue, or even particular types of human tissue. Therefore, the techniques are capable of determining a person's body or skin temperature, heart rate, perspiration, stress level, hydration level, and so forth.

At 806, the requested search is performed using the a search query and the determined physiological information about the person. Any suitable information sources may be searched, such as the Internet, an intranet, local device data, a search history associated with a user, a location history associated with the user, social media, calendar information, and the like.

At 808, the search results resulting from performing the requested search using the search query and the determined physiological information is provided. By way of example, assume that a person requests a search of “find a good place for a drink.” If, at 804, search manager 104 determined that the person is dehydrated, search manager 104 may present lower-rated stores and cafés near the person but, if the person is not dehydrated, instead present better-rated stores and cafés further from the person. If, on the other hand, the physiological information indicates a physical orientation, such as a gate and direction of the person and thus that the person is walking a particular direction, to present search results along the particular direction rather than simply near (and possible behind, left, or right from) the person.

While the above examples are directed to Internet searches, these are not the only computer-aided searches contemplated by the techniques. File searches, media searches, such as searching metadata for audio-visual media 602 instead of an Internet search, catalog or list searches, and so forth can benefit from the techniques.

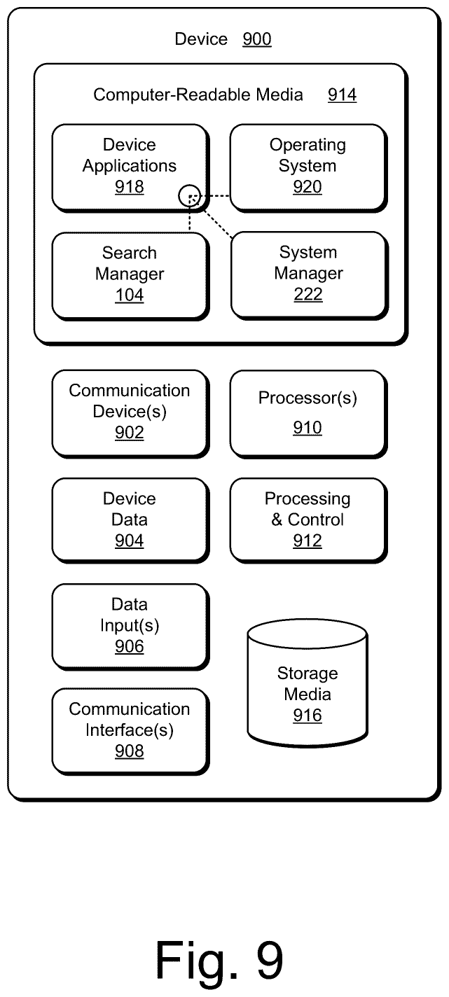

The preceding discussion describes methods relating to radar recognition-aided searches. Aspects of these methods may be implemented in hardware (e.g., fixed logic circuitry), firmware, software, manual processing, or any combination thereof. These techniques may be embodied on one or more of the entities shown in FIGS. 1, 2, 4, 6, 7, and 9 (electronic device 900 is described in FIG. 9 below), which may be further divided, combined, and so on. Thus, these figures illustrate some of the many possible systems or apparatuses capable of employing the described techniques. The entities of these figures generally represent software, firmware, hardware, whole devices or networks, or a combination thereof.

### Example Electronic Device

FIG. 9 illustrates various components of example electronic device 900 (device 900) that can be implemented as any type of client, server, and/or computing device as described with reference to the previous FIGS. 1-8 to implement radar recognition-aided searches.

Device 900 includes communication devices 902 that enable wired and/or wireless communication of device data 904 (e.g., received data, data that is being received, data scheduled for broadcast, data packets of the data, etc.). Device data 904 or other device content can include configuration settings of the device, media content stored on the device, and/or information associated with a user of the device (e.g., an identity of an actor performing a gesture). Media content stored on device 900 can include any type of audio, video, and/or image data. Device 900 includes one or more data inputs 906 via which any type of data, media content, and/or inputs can be received, such as human utterances, interactions with a radar field, user-selectable inputs (explicit or implicit), messages, music, television media content, recorded video content, and any other type of audio, video, and/or image data received from any content and/or data source.

Device 900 also includes communication interfaces 908, which can be implemented as any one or more of a serial and/or parallel interface, a wireless interface, any type of network interface, a modem, and as any other type of communication interface. Communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like), which process various computer-executable instructions to control the operation of device 900 and to enable techniques for, or in which can be embodied, a radar recognition-aided search. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device (storage media) 916.

Computer-readable media 914 provides data storage mechanisms to store device data 904, as well as various device applications 918 and any other types of information and/or data related to operational aspects of device 900. For example, an operating system 920 can be maintained as a computer application with computer-readable media 914 and executed on processors 910. Device applications 918 may include a device manager, such as any form of a control application, software application, signal-processing and control module, code that is native to a particular device, a hardware abstraction layer for a particular device, and so on. Device applications 918 also include system components, engines, or managers to implement radar recognition-aided searches, such as search manager 104 and system manager 222.

### CONCLUSION

Although embodiments of techniques enabling radar recognition-aided searches have been described in language specific to features and/or methods, it is to be understood that the subject of the appended claims is not necessarily limited to the specific features or methods described. Rather, the specific features and methods are disclosed as example implementations of ways in which to perform a radar recognition-aided search.

What is claimed is:

1. A method performed by a device, the method comprising:
determining physiological information associated with a person;
detecting verbalization expressed by the person, the verbalization comprising a question;
causing a search to be performed, the search based on the question and refined using the physiological information; and
providing search results responsive to the question.

2. The method of claim 1, wherein the determining of the physiological information comprises determining the physiological information associated with the person via a radar-based recognition system of the device.

3. The method of claim 2, further comprising:
providing, via the radar-based recognition system, a radar field that reflects off at least a portion of the person; and
sensing, via the radar-based recognition system, the physiological information associated with the person based on reflections of the radar field.

4. The method of claim 1, wherein the physiological information relates to at least one of the following:
a biological characteristic or condition of the person; or
a physical orientation of the person.

5. The method of claim 4, wherein the biological characteristic or condition comprises at least one of the following:
a body temperature of the person;
a skin temperature of the person;
a heart rate of the person;
an indication of perspiration on the person;
a hunger level of the person;
a stress level of the person; or
a hydration level of the person.

6. The method of claim 1, wherein the refining of the search comprises refining the search sufficient to provide the search results that vary in at least one of relevancy, quality, verbosity, temporal proximity, or geographic proximity.

7. The method of claim 1, wherein:
the question indicates a desire for a drink;
the physiological information indicates that the person is dehydrated; and
the refining of the search comprises refining the search based on the indication that the person is dehydrated sufficient to provide the search results prioritizing a proximity to the person and a relevancy to the question.

8. The method of claim 1, wherein:
the question indicates a desire for a drink;
the physiological information indicates that the person is hydrated; and
the refining of the search comprises refining the search based on the indication that the person is hydrated sufficient to provide the search results prioritizing ratings and a relevancy to the question.

9. The method of claim 1, wherein:
the question indicates a desire for food or drink;
the physiological information indicates an orientation of the person; and
the refining of the search comprises refining the search based on the orientation of the person sufficient to provide the search results along a direction corresponding to the orientation of the person and a relevancy to the question.

10. The method of claim 1, further comprising:
recognizing an in-the-air gesture performed by the person using a radar-based recognition system of the device,
wherein the causing the search to be performed comprises refining the search using the physiological information and a determined meaning of the in-the-air gesture that is relevant to the question.

11. The method of claim 10, wherein:
the in-the-air gesture has multiple potential meanings; and
the method further comprises determining the meaning of the in-the-air gesture based on a comparison of the multiple potential meanings associated with the in-the-air gesture in combination with the question.

12. A computing device comprising:
a search manager configured to cause the computing device to:
identify a verbalization expressed by a person, the verbalization comprising a question;
cause a search to be performed, the search based on the question and refined using physiological information associated with the person; and
provide, via the computing device, search results responsive to the question.

13. The computing device of claim 12, further comprising:
a radar based-recognition system configured to determine the physiological information associated with the person.

14. The computing device of claim 12, wherein the physiological information comprises at least one of the following:
an orientation of the person;
a body temperature of the person;
a skin temperature of the person;
a heart rate of the person;
an indication of perspiration on the person;
a hunger level of the person;
a stress level of the person; or
a hydration level of the person.

15. The computing device of claim 12, further comprising a display configured to present the search results.

16. The computing device of claim 12, wherein the computing device comprises a portable wireless communication device being a smartphone or a wearable device.

17. The computing device of claim 12, wherein the person is a user of the computing device.

18. A computer-readable storage medium comprising instructions that, responsive to execution by a processor, cause a device to:
determine physiological information associated with a person;
detect verbalization expressed by the person, the verbalization comprising a question;
perform a search, the search based on the question and refined using the physiological information; and
provide search results responsive to the question.

19. The computer-readable storage medium of claim 18, wherein the computer-readable storage medium causes the device to determine physiological information associated with the person based on received reflections from a radar field that interacts with at least a portion of the person.

20. The computer-readable storage medium of claim 18, wherein the physiological information comprises at least one of the following:
an orientation of the person;
a body temperature of the person;
a skin temperature of the person;
a heart rate of the person;
an indication of perspiration on the person;
a hunger level of the person;
a stress level of the person; or
a hydration level of the person.
